(19) United States
(12) Patent Application Publication
(10) Pub. No.: US 2021/0132705 A1
(43) Pub. Date: May 6, 2021

(54) INFORMATION PROCESSING APPARATUS, INFORMATION PROCESSING METHOD, AND RECORDING MEDIUM

(71) Applicant: SONY CORPORATION, Tokyo (JP)

(72) Inventors: Yu AOKI, Tokyo (JP); Kentaro IDA, Tokyo (JP); Takuya IKEDA, Tokyo (JP); Fumihiko IIDA, Kanagawa (JP)

(73) Assignee: SONY CORPORATION, Tokyo (JP)

(21) Appl. No.: 17/254,595

(22) PCT Filed: Jun. 19, 2019
(86) PCT No.: PCT/JP2019/024213

§ 371 Date: Dec. 21, 2020

(30) Foreign Application Priority Data
Jul. 3, 2018 (JP) 2018-126759

(51) Int. Cl. G06F 3/0354; G06F 3/03; G06F 3/042

(52) U.S. Cl. CPC G06F 3/03542; G06F 3/0425; G06F 3/0304

(57) ABSTRACT

The present technology relates to an information processing apparatus capable of improving detection accuracy in detecting a pointed position by a pointing apparatus, an information processing method, and a recording medium. An information processing apparatus includes: a pointed position detection unit configured to detect a pointed position pointed in a space with a pointing light ray from a pointing apparatus, on the basis of output information indicating an output state of the pointing light ray and sensor data detected in the space; and a pointing light ray control unit configured to control output of the pointing light ray from the pointing apparatus on the basis of a result of detection on the pointed position. The present technology is applicable to, for example, an apparatus that controls a drive-type projector.

### TECHNICAL FIELD

The present technology relates to an information processing apparatus, an information processing method, and a recording medium, and particularly relates to an information processing apparatus with improved detection accuracy in detecting a pointed position by a pointing apparatus, an information processing method, and a recording medium.

### BACKGROUND ART

Heretofore, it has been proposed that in a case where a projected image projected through filter segments for a plurality of colors of a color wheel is pointed by a laser pointer, it is possible to stably detect an irradiation point of a laser light ray in such a manner that an image of a projection surface is captured during a period in which a projection light ray from a filter segment close to a color of the laser pointer is not projected onto the projection surface (see, for example, Patent Document 1).

### CITATION LIST

### Patent Document

Patent Document 1: Japanese Patent Application Laid-Open No. 2015-37250

### SUMMARY OF THE INVENTION

### Problems to be Solved by the Invention

According to the invention described in Patent Document 1, however, it is impossible to improve detection accuracy in detecting an irradiation point of (i.e., a pointed position by) the laser pointer in a case other than the case where the projected image is pointed by the laser pointer.

The present technology has been made in view of the circumstances described above, and is directed to an improvement in a detection accuracy in detecting a pointed position by a pointing apparatus.

### Solutions to Problems

An information processing apparatus according to an aspect of the present technology includes: a pointed position detection unit configured to detect a pointed position pointed in a space with a pointing light ray from a pointing apparatus, on the basis of output information indicating an output state of the pointing light ray and sensor data detected in the space; and a pointing light ray control unit configured to control output of the pointing light ray from the pointing apparatus on the basis of a result of detection on the pointed position.

An information processing method according to an aspect of the technology includes: detecting a pointed position pointed in a space with a pointing light ray from a pointing apparatus, on the basis of output information indicating an output state of the pointing light ray and sensor data detected in the space; and controlling output of the pointing light ray on the basis of a result of detection on the pointed position.

A recording medium according to an aspect of the present technology records a program causing a computer to execute processing of: detecting a pointed position pointed in a space with a pointing light ray from a pointing apparatus, on the basis of output information indicating an output state of the pointing light ray and sensor data detected in the space; and controlling output of the pointing light ray on the basis of a result of detection on the pointed position.

According to an aspect of the present technology, a pointed position pointed in a space with a pointing light ray from a pointing apparatus is detected on the basis of output information indicating an output state of the pointing light ray and sensor data detected in the space, and output of the pointing light ray from the pointing apparatus is controlled on the basis of a result of detection on the pointed position.

### Effects of the Invention

According to an aspect of the present technology, it is possible to improve detection accuracy in detecting a pointed position by a pointing apparatus.

Note that the effects described herein are not necessarily limitative, and there may be achieved any one of the effects described in the present disclosure.

### BRIEF DESCRIPTION OF DRAWINGS

FIG. 1 is a block diagram that illustrates a first embodiment of an information processing system to which the present technology is applied.

FIG. 2 is a block diagram that illustrates a configuration example of a sensor unit, an information processing apparatus, and a processing unit.

FIG. 3 is a block diagram that illustrates a configuration example of a pointing apparatus.

FIG. 4 is a diagram that illustrates a setup example of the information processing apparatus.

FIG. 5 is an explanatory flowchart of pointed position detection processing.

FIG. 6 is a diagram that illustrates an image example is a case where a pointed position is successfully detected.

FIG. 7 is a diagram that illustrates an image example is a case where detection of a pointed position is failed.

FIG. 8 is a diagram that illustrates an image example in a case where detection of a pointed position is failed.

FIG. 9 is a diagram that illustrates an image example in a case where detection of a pointed position is failed.

FIG. 10 is an explanatory flowchart of details of control parameter adjustment processing.

FIG. 11 is a diagram that illustrates a second embodiment of an information processing system to which the present technology is applied.

FIG. 12 is a diagram that illustrates a third embodiment of an information processing system to which the present technology is applied.

FIG. 13 is a diagram that illustrates a configuration example of a computer.

### MODE FOR CARRYING OUT THE INVENTION

Hereinafter, a description will be given of modes for carrying out the present technology. The description is given in the following order.

1. First Embodiment

2. Second Embodiment

3. Third Embodiment

4. Modifications

5. Others

### 1. First Embodiment

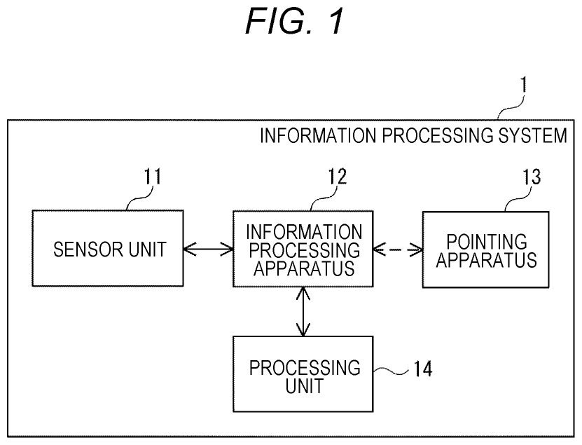

With reference to FIGS. 1 to 11, first, a description will be given of a first embodiment of the present technology.

<Configuration Example of Information Processing System 1>

FIG. 1 is a block diagram that illustrates a configuration example of an information processing system. 1 to which the present technology is applied.

The information processing system 1 includes a sensor unit 11, an information processing apparatus 12, a pointing apparatus 13, and a processing unit 14.

The sensor unit 11 detects a situation of a space in which a position is pointed by the pointing apparatus 13, that is, a space in which a pointed position is pointed with a pointing light ray output from the pointing apparatus 13 (hereinafter, referred to as a point target space). The sensor unit 11 supplies, to the information processing apparatus 12, sensor data indicating a result of detection on the situation of the point target space.

The information processing apparatus 12 detects the pointed position by the pointing apparatus 13 on the basis of the sensor data from the sensor unit 11 and output information indicating an output state of the pointing light ray from the pointing apparatus 13. The information processing apparatus 12 supplies, to the processing unit 14, pointed position information indicating a result of the detection on the pointed position. Furthermore, the information processing apparatus 12 sets sensor parameters for use in controlling the sensor unit 11, on the basis of the result of detection on the pointed position, and the like, and supplies the sensor parameters to the sensor unit 11. Moreover, the information processing apparatus 12 generates output control information for use in controlling output of the pointing light ray from the pointing apparatus 13, on the basis of the result, of detection on the pointed position, and the like, and transmits the output control information to the pointing apparatus 13.

The pointing apparatus 13 is configured with, for example, an irradiation-type pointing apparatus that outputs a pointing light ray to point a pointed position from a position irradiated with the pointing light ray. For example, the pointing apparatus 13 is configured with a laser marker or the like. The pointing apparatus 13 controls the output of the pointing light ray on the basis of the output control information received from the information processing apparatus 12. Furthermore, the pointing apparatus 13 generates output information indicating the output state of the pointing light ray, and transmits the output information to the information processing apparatus 12.

The processing unit 14 carries out various processing tasks on the basis of the result of detection on the pointed position.

<Configuration Example of Sensor Unit 11, Information Processing Apparatus 12, and Processing Unit 14>

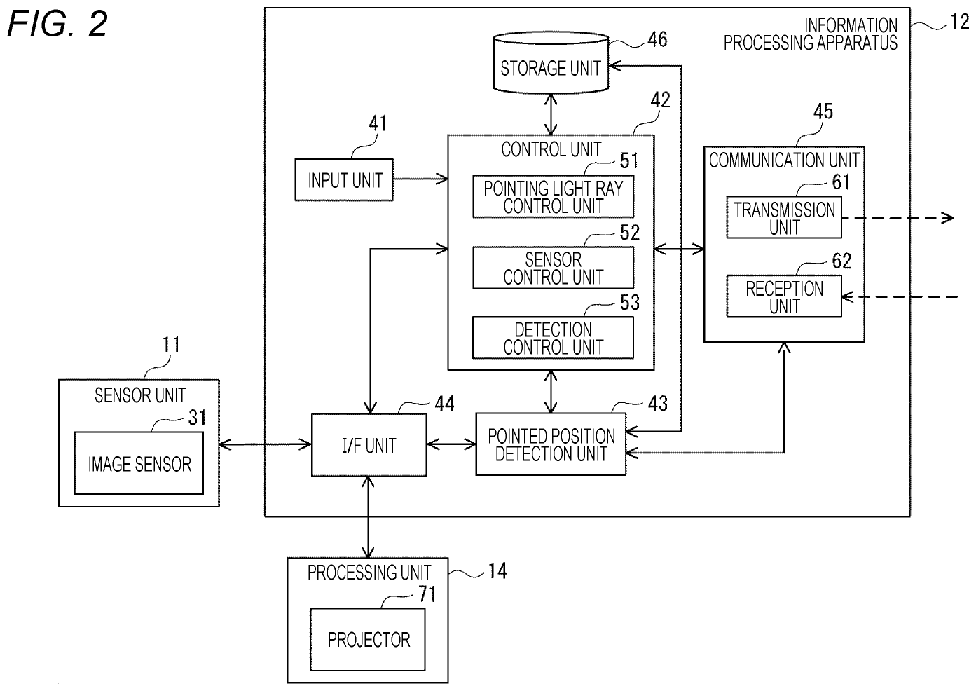

FIG. 2 illustrates a configuration example of the sensor unit 11, information processing apparatus 12, and processing unit 14.

The sensor unit 11 includes, for example, an image sensor 31 such as a camera. The image sensor 31 captures an image of the point target space, and supplies data on the captured image thus obtained to the information processing apparatus 12.

The information processing apparatus 12 includes an input unit 41, a control unit 42, a pointed position detection unit 43, an interface (I/F) unit 44, a communication unit 45, and a storage unit 46.

The input unit 41 includes, for example, operating devices such as a touch panel, a button, a microphone, a switch, and a lever. The input unit 41 generates an input signal on the basis of data, an instruction, and the like input by a user, and supplies the input signal to the control unit 42.

The control unit 42 controls various processing tasks on the sensor unit 11, information processing apparatus 12, pointing apparatus 13, and processing unit 14, on the basis of the input signal from the input unit 41, the data on the captured image from the image sensor 31, the output information from the pointing apparatus 13, and the like. The control unit 42 includes a pointing light ray control unit 51, a sensor control unit 52, and a detection control unit 53.

The pointing light ray control unit 51 controls the output of the pointing light ray from the pointing apparatus 13. For example, the pointing light ray control unit 51 controls a method of outputting the pointing light ray from the pointing apparatus 13. More specifically, for example, the pointing light ray control unit 51 sets output parameters indicating the method of outputting the pointing light ray, and generates output control information containing the output parameters. The pointing light ray control unit 51 transmits the output control information to the pointing apparatus 13 via the communication unit 45. Furthermore, the pointing light ray control unit 51 stores the output parameters in the storage unit 46.

The sensor control unit 52 controls an image capturing operation by the image sensor 31 in the sensor unit 11. For example, the sensor control unit 52 sets sensor parameters for use in controlling the image capturing operation by the image sensor 31. The sensor control unit 52 supplies the sensor parameters to the sensor unit 11 via the I/F unit 44, and stores the sensor parameters in the storage unit 46.

The detection control unit 53 controls the detection of the pointed position by the pointed position detection unit 43. For example, the detection control unit 53 sets detection parameters for use in detecting the pointed position. The detection control unit 53 supplies the detection parameters to the pointed position detection unit 43, and stores the detection parameters in the storage unit 46.

The pointed position detection unit 43 carries out processing of detecting the pointed position by the pointing apparatus 13, on the basis of the captured image from the image sensor 31, the output information from the pointing apparatus 13, and the detection parameters. The pointed position detection unit 43 supplies, to the control unit 42, pointed position information indicating the result of detection on the pointed position. In addition, the pointed position detection unit 43 supplies the pointed position information to the processing unit 14 via the I/F unit 44, and stores the pointed position information in the storage unit 46.

The I/F unit 44 performs data exchange between the sensor unit 11 and the processing unit 14, and the like. Note that the information processing apparatus 12 may communicate with the sensor unit 11 and the processing unit 14 in either a wired manner or a wireless manner.

The communication unit 45 communicates with the pointing apparatus 13. The communication unit 45 includes a transmission unit 61 and a reception unit 62.

The transmission unit 61 communicates with the pointing apparatus 13 in a wireless manner to transmit information such as the output control information to the pointing apparatus 13.

The reception unit 62 communicates with the pointing apparatus 13 in a wireless manner to receive information such as the output information from the pointing apparatus 13, and supplies the information to the control unit 42 and the pointed position detection unit 43.

The storage unit 46 stores information and the like, such as control parameters (the output parameters, the sensor parameters, and the detection parameters), necessary for treatment in the information processing apparatus 12.

The processing unit 14 includes a projector 71.

The projector 71 is configured with a drive-type projector capable of projecting an image in various directions. The projector 71 controls an image projection position on the basis of the pointed position information.

<Configuration Example of Pointing Apparatus 13>

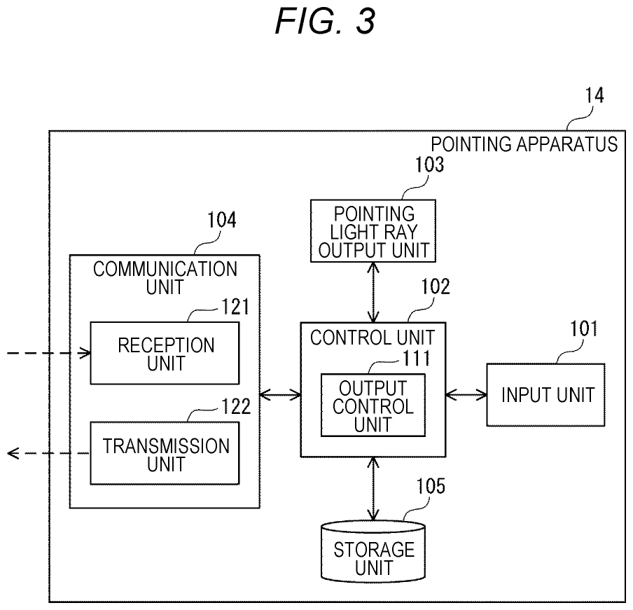

FIG. 3 illustrates a configuration example of the pointing apparatus 13.

The pointing apparatus 13 includes an input unit 101, a control unit 102, a pointing light ray output unit 103, a communication unit 104, and a storage unit 105.

The input unit 101 includes, for example, operating devices such as a button and a switch. The input unit 101 is used for, for example, an operation to switch on/off power supply to the pointing apparatus 13, an operation to switch on/off out of the pointing light ray, and the like. The input unit 101 generates an input signal on the basis of data, an instruction, and the like input by the user, and supplies the input signal to the control unit 102.

The control unit 102 controls various processing tasks by the pointing apparatus 13 on the basis of the input signal from the input unit 41, the output control information from the information processing apparatus 12, and the like. The control unit 102 includes an output control unit 111.

The output control unit 111 controls the output of the pointing light ray from the pointing light ray output unit 103 on the basis of the input signal from the input unit 101 and the output control information from the information processing apparatus 12. Furthermore, the output control unit 111 stores the output control information in the storage unit 105. Moreover, the output control unit 111 generates output information indicating the output state of the pointing light ray, and supplies the output information to the communication unit 104.

The pointing light ray output unit 103 includes, for example a laser light source, an LED, or the like. The pointing light ray output unit 103 controls the output of the pointing light ray under the control by the output control unit 111.

Note that the pointing light ray may be a visible light ray or an invisible light ray such as an infrared light ray. In a case where the pointing light ray is an infrared light ray, for example, an image sensor capable of detecting the infrared light ray is used as the image sensor 31. Furthermore, the wavelength (color) of the pointing light ray may be variable or fixed.

Note that, hereinafter, a description will be given of an example of a case where the pointing light ray is a visible light ray and the color is variable.

The communication unit 104 communicates with the information processing apparatus 12. The communication unit 104 includes a reception unit 121 and a transmission 122.

The reception unit 121 communicates with the transmission unit 61 of the information processing apparatus 12 in a wireless manner to receive information such as the output control information from the transmission unit 61, and supplies the information to the control unit 102.

The transmission unit 122 communicates with the reception unit 62 of the information processing apparatus 12 in a wireless manner to transmit information such as the output information to the reception unit 62.

The storage unit 105 stores information and the like, such as the output control information, necessary for processing in the pointing apparatus 13.

<Setup Example of Information Processing System 1>

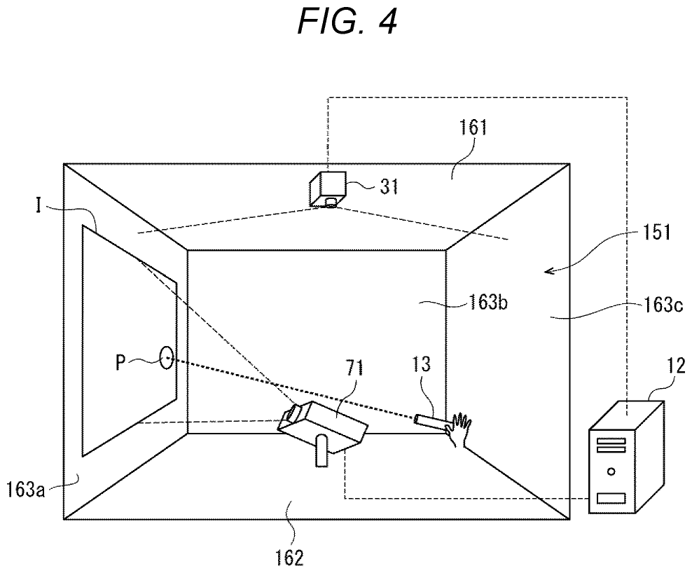

FIG. 4 illustrates a setup example of the information processing system 1.

In the example illustrated in FIG. 4, the information processing system 1 is set up in a room 151 as a point target space. The room 151 is a space surrounded by a ceiling 161, a floor 162, and walls 163a to 163d (however, the wall 163d is not illustrated in the figure).

Note that the walls 163a to 163d will be simply referred to as the wall(s) 163 below in a case where they are not necessarily differentiated from one another.

The image sensor 31 is placed to look down the entire room 151 from the ceiling 161, and captures an image of the interior of the room 151.

The projector 71 is placed on the floor 162, and moves a projection position of an image I in accordance with a pointed position P by the pointing apparatus 13. For example, the projector 71 projects the image I onto the wall 163, at which the pointed position P is detected, among the walls 163a to 163d.

The information processing apparatus 12 may be placed inside the room 151 or may be placed outside the room 151.

Note that the position of the image sensor 31 and the position of the projector 71 are changed in accordance with a projecting range of the image I, and the like.

<Pointed Position Detection Processing>

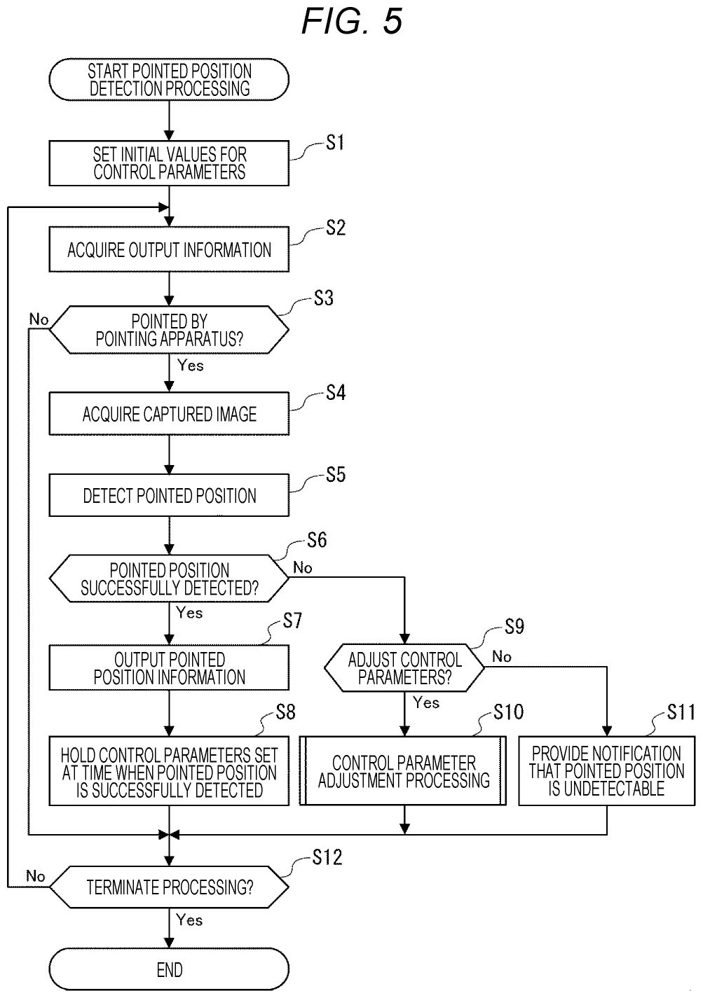

With reference to a flowchart of FIG. 5, next, a description will be given of pointed position detection processing to be executed by the information processing apparatus 12.

For example, this processing is started when an instruction to start the pointed position detection processing is input to the control unit 42 through the input unit 41.

In step S1, the control unit 42 sets initial values for the control parameters.

Specifically, the pointing light ray control unit 51 reads initial values of the output parameters from the storage unit 46, and generates output control information containing the output parameters thus read. The pointing light ray control unit 51 transmits the output control information to the pointing apparatus 13 through the transmission unit 61.

The output parameters include, for example, an intensity, a sectional shape, a color, and a temporal pattern of a pointing light ray.

Note that the sectional shape of the pointing light ray represents a size and a shape of the pointing light ray in sectional view. When the size or shape of the pointing light ray in sectional view changed, a size or a shape of an image to be formed on a wall or the like irradiated with the pointing light ray (hereinafter, referred to as a pointing image) is changed.

The temporal pattern of the pointing light ray represents, for example, a time-series change pattern of the pointing light ray. For example, the temporal pattern of the pointing light ray represents a blinking pattern of the pointing light ray, that is, a pattern of a lighting time and an extinguishing time in a case where the pointing light ray repeatedly blinks. Alternatively, for example, the temporal pattern of the pointing light ray represents a value of u parameter, a time when the value is changed, and the like in a case where at least one or more parameters among the intensity, color, sectional size, and sectional shape of the pointing light ray are changed in a time-series manner.

Note that the initial value of each output parameter to be used herein is, for example, a predetermined default value or a value used when a pointed position was successfully detected in preceding pointed position detection processing.

In response to this, the output control unit 111 of the pointing apparatus 13 receives the output control information through the reception unit 121. The pointing light ray output unit 103 outputs the pointing light ray under the control by the output control unit 111, on the basis of the output parameters contained in the output control information. That is, the intensity, shape, color, and temporal pattern of the pointing light ray are controlled with the output parameters.

The sensor control unit 52 reads initial values of the sensor parameters for the image sensor 31 from the storage unit 46, and supplies the initial value to the sensor unit 11 via the I/F unit 44.

The sensor parameters include, for example, image capturing parameters for the image sensor 31. Specifically, the sensor parameters include, for example, a shutter speed, a gain, an aperture, and the like of the image sensor 31.

Note that the initial value of each sensor parameter to be used herein is, for example, a predetermined default value or a value used when a pointed position was successfully detected in preceding pointed position detection processing.

In response to this, the image sensor 31 captures an image of the interior of the point target space on the basis of the sensor parameters set by the sensor control unit 52.

The detection control unit 53 reads initial values of the detection parameters for the pointed position detection unit 43 from the storage unit 46, and supplies the initial values to the pointed position detection unit 43.

The detection parameters include, for example, a parameter for use in detecting a pointing image in a captured image, and are set in accordance with the output parameters, the sensor parameters, and the like. Specifically, the detection parameters include, for example, a brightness, a size, a shape, a color, and a temporal pattern of a pointing image to be detected.

Note that as to the brightness, size, shape, and color of the pointing image, for example, a range is set for each parameter. For example, a range of the brightness of the pointing image is set on the basis the intensity and the like of the pointing light ray. Furthermore, the temporal pattern of the pointing image is set in accordance with the temporal pattern of the pointing light ray.

Note that the initial value of each detection parameter to be used herein is, for example, a predetermined default value or a value used when a pointed position was successfully detected in preceding pointed position detection processing. Alternatively, for example, the initial values of the detection parameters may be set on the basis of the initial values of the output parameters and the initial values of the sensor parameters.

In step S2, the pointed position detection unit 43 acquires output information.

Specifically, the output control unit 111 of the pointing apparatus 13 generates output information indicating an output state of the pointing light ray, and transmits the output information to the information processing apparatus 12 through the transmission unit 122.

The output information contains, for example, presence or absence of output of the pointing light ray and a method of outputting the pointing light ray.

The presence or absence of output of the pointing light ray indicates that whether or not the pointing light ray is output from the pointing light ray output unit 103.

The method of outputting the pointing light ray includes, for example, the output parameters for use in outputting the pointing light ray.

The pointed position detection unit 43 receives the output information transmitted from the pointing apparatus 13, through the reception unit 62.

In step S3, the pointed position detection unit 43 determines whether or not the pointing apparatus 13 points a position. The pointed position detection unit 43 determines that the pointing apparatus 13 points a position in a case where the output information indicates that the pointing apparatus 13 outputs the pointing light ray. The processing then proceeds to step S4.

In step S4, the pointed position detection unit 43 acquires a captured image.

Specifically, the image sensor 31 captures an image of the interior of the point target space, and supplies data of the captured image thus obtained to the information processing apparatus 12.

The pointed position detection unit 43 acquires the data of the captured image supplied from the image sensor 31, via the I/F unit 44.

In step S5, the pointed position detection unit 43 detects the pointed position. Specifically, the pointed position detection unit 43 detects the pointing image in the captured image on the basis of the detection parameters. Furthermore, in a case where the pointing image is successfully detected, the pointed position detection unit 43 detects the pointed position in the point target space on the basis of the position of the pointing image in the captured image.

In step S6, the pointed position detection unit 43 determines whether or not the pointed position is successfully detected. In a case where it is determined that the pointed position is successfully detected, the processing proceeds to step S7.

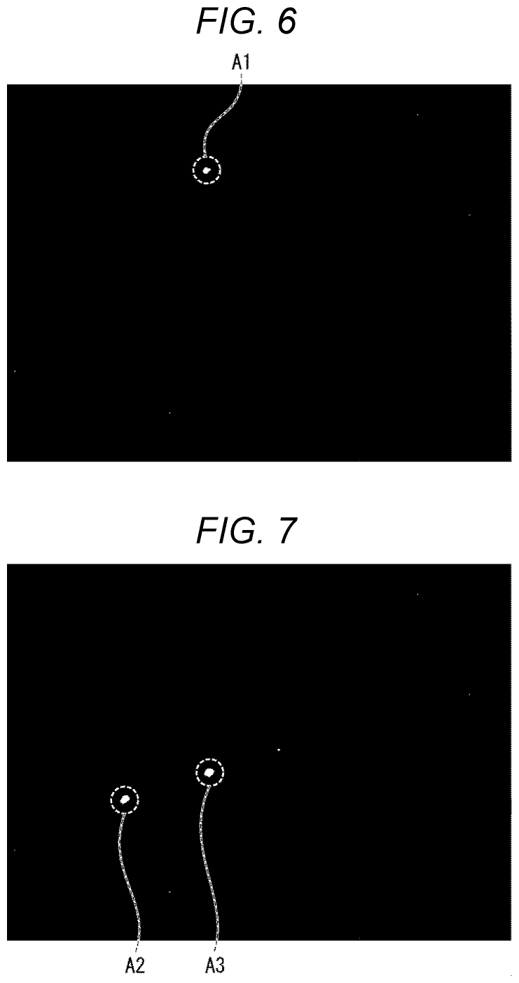

FIG. 6 illustrates an example of an image obtained by binarizing a captured image from which a pointed position is successfully detected. In the image illustrated in FIG. 6, a pointing image is present in a dotted frame A1, and a pointed position is detected on the basis of a position of this pointing image in the image.

In step S7, the pointed position detection unit 43 outputs pointed position information. Specifically, the pointed position detection unit 43 generates pointed position information containing a result of detection on the pointed position. The pointed position detection unit 43 supplies the pointed position information to the processing unit 14 via the I/F unit 44, and also supplies the pointed position information to the control unit 42.

In response to this, the projector 71 of the processing unit 14 controls a projection position of the image on the basis of, for example, the pointed position information. Specifically, the projector 71 sets the projection position of the image on the basis of the pointed position. For example, the projector 71 sets a predetermined range in which the pointed position is centered, for the projection position. Alternatively, for example, the projector 71 sets a predetermined position of a surface at which the pointed position is detected (e.g., any of the walls 163 illustrated in FIG. 4), for the projection position. The projector 71 then starts to project the image onto the projection position thus set.

In step S8, the information processing apparatus 12 holds the control parameters set at the time when the pointed position is successfully detected.

For example, the pointing light ray control unit 51 stores the current output parameters as the latest output parameters set at the time when the pointed position is successfully detected, in the storage unit 46. At this time, in a case where output parameters set at the time when a pointed position was successfully detected in the past are stored in the storage unit 46, the pointing light ray control unit 51 may keep or erase the past output parameters.

The sensor control unit 52 stores the current sensor parameters as the latest sensor parameters set at the time when the pointed position is successfully detected, in the storage unit 46. At this time, in a case where sensor parameters set at the time when a pointed position was successfully detected in the past are stored in the storage unit 46, the sensor control unit 52 may keep or erase the past sensor parameters.

The detection control unit 53 stores the current detection parameters as the latest detection parameters set at the time when the pointed position is successfully detected, in the storage unit 46. At this time, in a case where detection parameters set at the time when a pointed position was successfully detected in the past are stored in the storage unit 46, the detection control unit 53 may keep or erase the past detection parameters.

Thereafter, the processing proceeds to step S12.

On the other hand, in a case where it is determined in step S6 that the detection of the pointed position is failed, the processing proceeds to step S9.

FIGS. 7 to 9 each illustrate an example of an image obtained by binarizing a captured image in which detection of a pointed position is failed.

In the image illustrated in FIG. 7, objects are respectively detected as candidates for a pointing image in a dotted frame A2 and a dotted frame A3. That is, another object owing to noise (e.g., ambient light) or the like is detected in addition to a pointing image. In this case, it is difficult to distinguish the pointing image from the other object, so that the detection of the pointed position is failed.

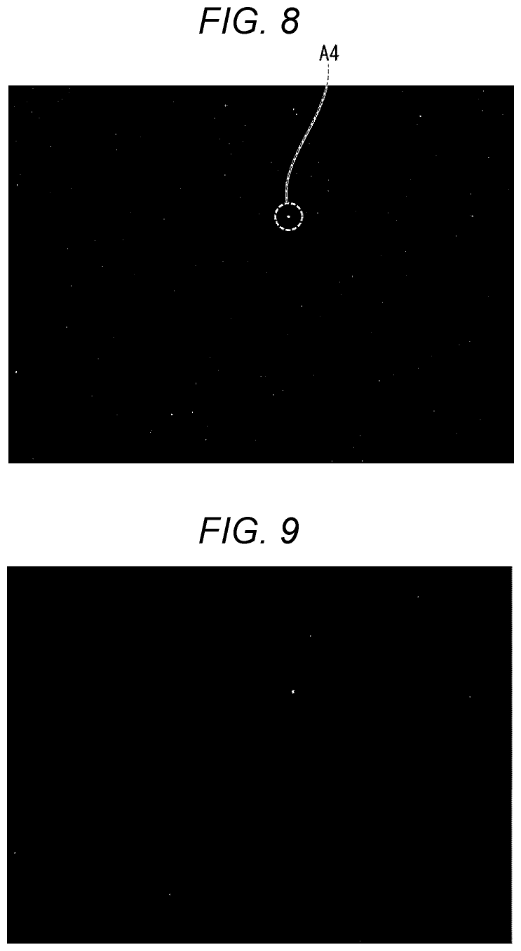

In the image illustrated in FIG. 8, a pointing image is present in a dotted frame A4. However, the pointing image in the frame A4 is small, and erroneous detection as noise or the like is assumed. Consequently, reliability as to a result of detection on the pointing image becomes very low. As a result, it is determined that the detection of the pointed position is failed.

In the image illustrated in FIG. 9, for example, a pointing image is very small or the brightness of a pointing image is very low. Consequently, an object as a candidate for a pointing image is not detected. As a result, the detection of the pointed position is failed.

In step S9, the control unit 42 determines whether or not to adjust the control parameters. For example, in a case where a pattern of the control parameters (a combination of control patterns) which has not been attempted yet remains, the control unit 42 determines to adjust the control parameters. The processing then proceeds to step S10.

In step S10, the information processing apparatus 12 executes control parameter adjustment processing. Thereafter, the processing proceeds to step S11.

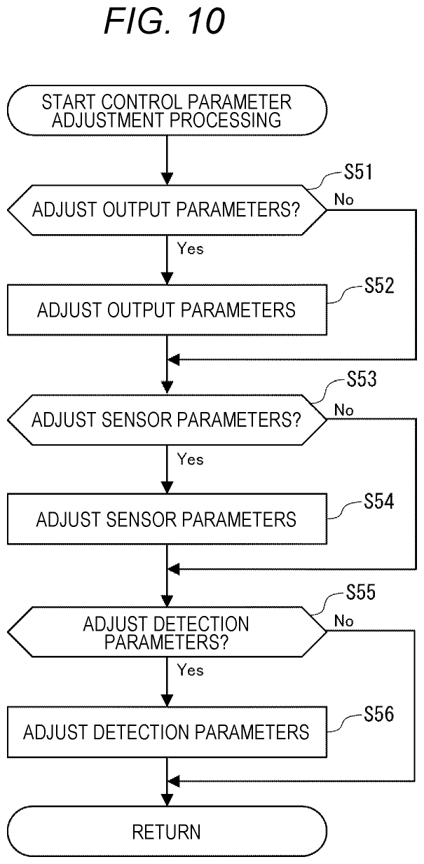

Here, with reference to a flowchart of FIG. 10, a description will be given of the details of the control parameter adjustment processing.

In step S51, the pointing light ray control unit 51 determines whether or not to adjust the output parameters. For example, in a case where a pattern of the output parameters (a combination of the output parameters) which has not been attempted yet remains, the pointing light ray control unit 51 determines to adjust the output parameters. The processing then proceeds to step S52.

In step S52, the pointing light ray control unit 51 adjusts the output parameters. For example, the pointing light ray control unit 51 adjusts the output parameters to improve the detection accuracy in detecting the pointed position such that the pointing image conspicuously appears in the captured image.

Note that any method can be set for the method adjusting the output parameters. For example, the output parameters are adjusted on the basis of the result of detection on the pointing image in the captured image.

For example, in the case where the plurality of candidates for the pointing image is detected as illustrated in the foregoing example of FIG. 7, the output parameters are adjusted such that the pointing image is explicitly distinguished from the other object.

For example, at least one of the color or the temporal pattern of the pointing light ray is preferentially changed. For example, the color of the pointing light ray is changed such that the color of the pointing image is different from the color of the other object. Alternatively, for example, the time-series change (e.g., blinking) of the pointing light ray is started or the temporal pattern (e.g., the blinking pattern) of the pointing light ray is changed.

In a case where the detection of the pointed position is failed although the color and temporal pattern of the pointing light ray are changed, for example, the sectional area of the pointing light ray is enlarged such that the pointing image becomes remarkably larger than the other object. In this case, since the sectional area of the pointing light ray is enlarged, the intensity of the pointing light ray is increased in a case where the brightness of the pointing image is lowered due to diffusion of light. Alternatively, for example, the sectional shape of the pointing light ray is changed such that the shape of the pointing image is different from the shape of the other object.

Furthermore, in the case where it is difficult to distinguish the pointing image from the noise as illustrated in the foregoing example of FIG. 8 and the case where no candidate for the pointing image is detected as illustrated in the foregoing example of FIG. 9, the output parameters are adjusted such that the pointing image is explicitly distinguished from the noise and the like.

For example, at least one of the intensity, the sectional size, or the sectional shape of the pointing light ray is preferentially changed. For example, the sectional area of the pointing light ray is enlarged such that the pointing image becomes remarkably larger than the noise. In this case, since the sectional area of the panting light ray is enlarged, the intensity of the pointing light ray is increased in a case where the brightness of the pointing image is lowered due to diffusion of light. Furthermore, for example, the sectional area shape of the pointing light ray is changed such that the shape of the pointing image is remarkably different from the noise and the like. In a case where the detection of the pointed position is failed although the intensity, sectional size, and sectional shape of the pointing light ray are changed, for example, the color or temporal pattern of the pointing light ray is changed.

Alternatively, for example, the pointing light ray control unit 51 changes the output parameters in a predetermined sequence irrespective of the result of detection on the pointing image in the captured image.

For example, the intensity of the pointing light ray is gradually increased at predetermined intervals.

Next, the sectional area of the pointing light ray is gradually enlarged at predetermined intervals.

Next, the shape of the pointing light ray is changed in a predetermined sequence.

Next, the color of the pointing light ray is changed in a predetermined sequence.

Next, the temporal pattern of the pointing light ray is changed in a predetermined sequence. For example, in a case where the pointing light ray is output to blink, the blinking intervals of the pointing light ray are gradually shortened.

Note that any sequence can be set for the sequence of changing the output parameters. Furthermore, two or more kinds of the output parameters may be changed at the same time.

Note that the intensity and temporal pattern of the pointing light ray particularly exert a significant influence on power consumption by the pointing apparatus 13. Hence, for example, it is desirable that after the successful detection of the pointed position, the intensity of the pointing light ray is decreased or the interval of the temporal pattern of the pointing light ray is extended to an extent that the detection of the pointed position is not failed.

The pointing light ray control unit 51 generates output control information containing the adjusted output parameters, and transmits the output control information to the pointing apparatus 13 through the transmission unit 61.

In response to this, the output control unit 111 the pointing apparatus 13 receives the output control information through the reception unit 121. The pointing light ray output unit 103 outputs the pointing light ray under the control by the output control unit 111, on the basis of the adjusted output parameters.

Thereafter, the processing proceeds to step S53.

On the other hand, in step S51, for example, in a case where the pointing light ray control unit 51 has already attempted all the patterns of the output parameters, the pointing light ray control unit 51 determines not to adjust the output parameters. As a result, the processing in step S52 is skipped, and the processing proceeds to step S53.

In step S53 the sensor control unit 52 determines whether or not to adjust the sensor parameters. For example, in a case where a pattern of the sensor parameters (a combination of the sensor parameters) which has not been attempted yet remains, the sensor control unit 52 determines to adjust the sensor parameters. The processing then proceeds to step S54.

In step S54, the sensor control unit 52 adjusts the sensor parameters.

For example, the sensor control unit 52 adjusts the shutter speed, gain, aperture, and the like of the image sensor 31 such that the brightness of the pointing image in the captured image takes an appropriate value.

The sensor control unit 52 supplies the adjusted sensor parameters to the sensor unit 11 via the I/F unit 44.

In response to this, the image sensor 31 captures an image of the interior of the point target space on the basis of the adjusted sensor parameters.

Thereafter, the processing proceeds to step S55.

On the other hand, in step S53, for example, in a case where the sensor control unit 52 has already attempted all the patterns of the sensor parameters, the sensor control unit 52 determines not to adjust the sensor parameters. As a result, the processing in step S54 is skipped, and the processing proceeds to step S55.

In step S55, the detection control unit 53 determines whether or not to adjust the detection parameters. For example, the detection control unit 53 makes a determination as to a necessity to change the detection parameters, on the basis of the details of adjustment on the output parameters and sensor parameters, and the like. In a case where the detection control unit 53 determines that it is necessary to change the detection parameters, the detection control unit 53 determines to adjust the detection parameters. The processing then proceeds to step S56.

In step S56, the detection control unit 53 adjusts the detection parameters. For example, the detection control unit 53 adjusts a brightness range, a size range, a shape range, a color range, and a temporal pattern of the pointing image to be detected, in accordance with the output parameters, the sensor parameters, and the like.

Note that, for example, the detection control unit 53 may adjust the detection parameters and make an attempt so as to detect the pointing image even if the output parameters and the sensor parameters are not changed.

Thereafter, the control parameter adjustment processing ends.

On the other hand, in a case where the detection control unit 53 determines in step S55 that it is unnecessary to change the detection parameters, the detection control unit 53 determines not to adjust the detection parameters. The control parameter adjustment processing thus ends.

Referring back to FIG. 5, on the other hand, in step S9, for example, in a case where the control unit 42 has already attempted all patterns of the control parameters, the control unit 42 determines not to adjust the control parameters. The processing then proceeds to step S11.

In step S11, the information processing apparatus 12 provides a notification that the pointed position is undetectable. For example, the pointed position detection unit 43 generates pointed position information indicating that the pointed position is undetectable, supplies the pointed position information to the processing unit 14 via the I/F unit 44, and also supplies the pointed position information to the control unit 42.

In response to this, for example, since the pointed position is undetectable, the projector 71 notifies the user that an image projection position is out of control, by a predetermined method.

Thereafter, the processing proceeds to step S12.

In step S12, the control unit 42 determines whether or not to terminate the processing. In a case where it is determined that the processing is not terminated, the processing returns to step S2.

Thereafter, the processing from step S2 to step S12 is repeatedly executed until it is determined in step S12 that the processing is terminated.

On the other hand, in step S12, for example, in a case where the control unit 42 receives an instruction to terminate the pointed position detection processing, through the input unit 41, the control unit 42 determines to terminate the processing. The pointed position detection processing thus ends.

As described above, the control parameters (the output parameters, the sensor parameters, and the detection parameters) are appropriately adjusted, so that the detection accuracy in detecting the pointed position is improved.

Furthermore, for example, a robust system is achieved with regard to a change and the like of an environment and the like. For example, even if an environment (e.g., an illumination environment or the like) of a point target space, a pointed position by the pointing apparatus 13, a position where the image sensor 31 is placed, and the like are changed, the control parameters are appropriately set, and therefore the detection accuracy in detecting the pointed position is favorably kept.

Moreover, since the user has no necessity to adjust the control parameters, the burden on the user is reduced.

Note that, for example, in a case where the information processing system 1 is set up in a place where a variation in conditions such as an environment is small, the foregoing pointed position detection processing can be applied to initial settings for the information processing system 1. That is, at the time of setup of the information processing system it is possible to detect and set appropriate control parameters for the setup place.

### 2. Second Embodiment

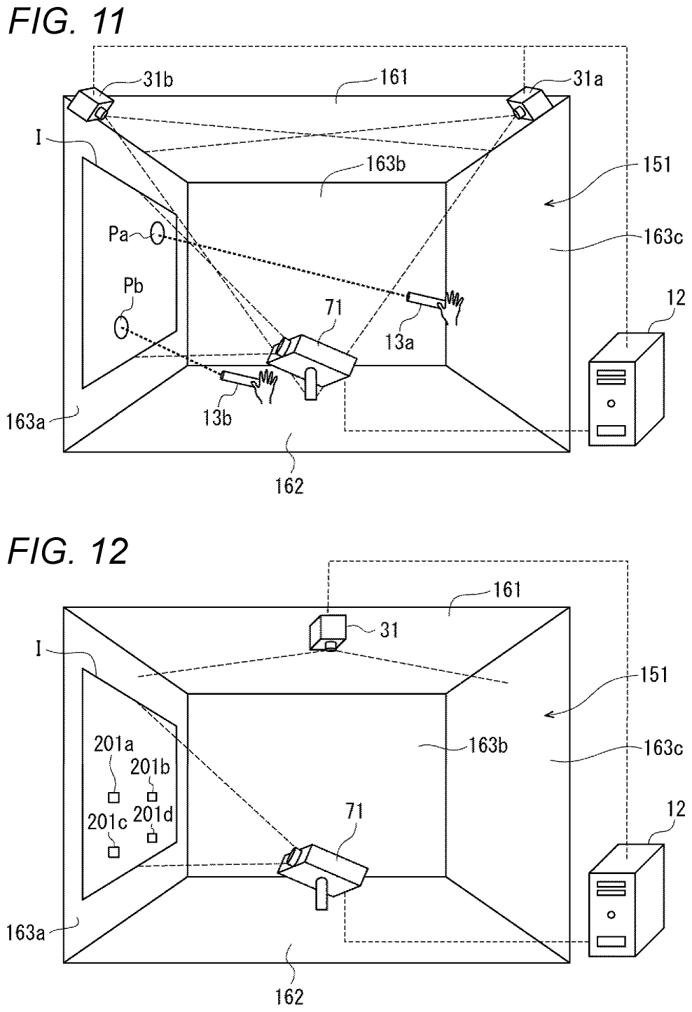

Next, with reference to FIG. 11, a description will be given of a second embodiment of the present technology.

In the second embodiment, two pointing apparatuses, that is, a pointing apparatus 13a and a pointing apparatus 13b as well as two image sensors, that is, an image sensor 31a and an image sensor 31b are provided.

Then, a pointed position Pa by the pointing apparatus 13a and a pointed position Pb the pointing apparatus 13b are detected on the basis of a captured image captured by the image sensor 31a and a captured image captured by the image sensor 31b.

In this case, a pointing light ray from the pointing apparatus 13a and a pointing light ray from the pointing apparatus 13b are controlled independently of each other. Then, for example, the respective pointing light rays are output by different output methods, respectively, such that the pointed position Pa and the pointed position Pb are explicitly distinguished from each other.

For example, the pointing light ray control unit 51 of the information processing apparatus 12 individually transmits output control information to the pointing apparatus 13a and the pointing apparatus 13b through the transmission unit 61. Then, different values are set for output parameters such that a pointing image formed by the pointing light ray from the pointing apparatus 13a can be explicitly distinguished from a pointing image formed by the pointing light ray from the pointing apparatus 13b. For example, different values are set for at least one of intensities, sectional sizes, sectional shapes, colors, or temporal patterns of the respective pointing light rays.

At this time, the output parameters for each pointing apparatus 13 and sensor parameters for each image sensor 31 can be appropriately set by the foregoing processing without complicated adjusting work.

Note that the number of pointing apparatuses 13 and the number of image sensors 31 can be set at three or more, respectively.

### 3. Third Embodiment

Next, with reference to FIG. 12, a description will be given of a third embodiment of the present technology.

The third embodiment describes an example in which output-type pointing apparatuses 201a to 201d each configured to point a pointed position at a position from which a pointing light ray is output are used in place of the irradiation-type pointing apparatus 13.

Hereinafter, the pointing apparatuses 201a to 201d will be simply referred to as the poi ting apparatus(es) 201 in a case where they are not necessarily differentiated from one another.

Each pointing apparatus 201 is configured with, for example, a placement-type marker. Each pointing apparatus 201 is placed at predetermined position on the wall 163a.

For example, the user selects a pointing apparatus 201 intended to output a pointing light ray, using the input unit 41 of the information processing apparatus 12. The pointing light ray control unit 51 of the information processing apparatus 12 generates output control information containing the output parameters, and transmits the output control information to the pointing apparatus 201 intended to transmit the pointing light ray, through the transmission unit 61.

The pointing apparatus 201, which has received the output control information, outputs the pointing light ray on the basis of the output parameters contained in the output control information. Then, the pointed position is pointed with the position of the pointing apparatus 201 which has output the pointing light ray, that is, the position from which the pointing light ray is output.

In response to this, the projector 71 controls a projection position of an image I on the basis of the pointed position, in a manner similar to that described in the foregoing example.

Furthermore, in a case where detection of the pointed position is failed, an intensity, a sectional size, a sectional shape, a color, and a temporal pattern of the pointing light ray from the pointing apparatus 201 are adjusted such that the pointed position is successfully detected, in a manner similar to that described in the foregoing example.

Note that the number a placement positions of the pointing apparatuses 201 in FIG. 12 are merely exemplary and can be changed arbitrarily. For example, the pointing apparatuses 201 can be placed on the ceiling 161, the floor 162, the wall 163 except the wall 163a, and the like.

### 4. Modifications

Hereinafter, a description will be given of modifications of the foregoing embodiments of the present technology.

<Modification Regarding Method of Controlling Control Parameters>

The foregoing method of controlling the control parameters is merely exemplary, and other methods can also be adopted.

For example, the information processing apparatus 12 may control the control parameters on the basis of an environment of a point target space.

For example, in the case of the irradiation-type pointing apparatus 13, a brightness and a size of a pointing image change depending on a distance between a surface irradiated with a pointing light ray (hereinafter, referred to as an irradiated surface) and the pointing apparatus 13. Hence, for example, at least one of an intensity or a sectional size of the pointing light ray may be controlled on the basis of the distance between the irradiated surface and the pointing apparatus 13. For example, as the distance between the irradiated surface and the pointing apparatus 13 is longer, the brightness of the pointing image is lower or the pointing image is smaller. Therefore, the intensity of the pointing light ray is increased or the sectional area of the pointing light ray is enlarged.

Note that the distance between the irradiated surface and the pointing apparatus 13 is detected in such a manner that, for example, the pointing apparatus 13 is provided with a distance measuring sensor or the like.

For example, in the case of the irradiation-type pointing apparatus 13, a brightness of a pointing image changes depending on a reflectance of an irradiated surface. Hence, for example, an intensity of the pointing light ray may be controlled on the basis of the reflectance of the irradiated surface. For example, as the reflectance of the irradiated surface is lower, the brightness of the pointing image is lower. Therefore, the intensity of the pointing light ray is increased.

Note that the reflectance of the irradiated surface is detected in such a manner that, for example, the sensor unit 11 or the pointing apparatus 13 is provided with a reflectance measuring sensor. Alternatively, in a case where the point target space is fixed, for example, a reflectance of each surface in the point target space may be measured in advance, and results of the measurement may be stored in the storage unit 46 of the information processing apparatus 12.

For example, even in each of the case of the irradiation-type pointing apparatus 13 and the case of the output-type pointing apparatuses 201, a color of illumination in the point target space exerts an influence on detection accuracy in detecting a pointing image. For example, as the color of the pointing light ray becomes closer to the color of illumination, the detection accuracy in detecting the pointing image is degraded. As a result, the detection accuracy in detecting the pointed position is degraded. Hence, for example, the color of the pointing light ray may be controlled in accordance with the color of illumination. For example, the color of the pointing light ray is set at a color that is largely different from a color of an illumination light ray.

Note that the color of illumination is detected on the basis of, for example, a captured image captured by the image sensor 31. Alternatively, for example, the sensor unit 11 may be provided with a spectroscope or the like to detect the color of illumination.

For example, even in each of the case of the irradiation-type pointing apparatus 13 and the case of the output-type pointing apparatuses 201, a color of a surface to which a pointed position is pointed (hereinafter, referred to as a pointed surface) exerts an influence on detection accuracy in detecting a pointing image. Note that in the case of the irradiation-type pointing apparatus 13, the pointed surface becomes equal to the irradiated surface. In the case of the output-type pointing apparatuses 201, for example, the surface on which the pointing apparatuses 201 are provided serves as a pointed surface. For example, as the color of the pointing light ray becomes closer to the color of the pointed surface, the detection accuracy in detecting the pointing image is degraded. As a result, the detection accuracy in detecting the pointed position is degraded. Hence, for example, the color of the pointing light ray may be controlled in accordance with the color of the pointed surface. For example, the color of the pointing light ray is set at a color that is largely different from the color of the pointed surface.

Note that the color of the pointed surface is detected on the basis of, for example, the captured image captured by the image sensor 31. Alternatively, for example, the sensor unit 11 may be provided with a spectroscope or the like to detect the color of the pointed surface.

For example, even in each of the case of the irradiation-type pointing apparatus 13 and the case of the output-type pointing apparatuses 201, a color of an image projected onto a pointed surface exerts an influence on detection accuracy in detecting a pointing image. For example, in a case where the projector 71 outputs projection light rays of the respective colors in a time-division manner like Digital Light Processing (DLP; registered trademark) (e.g., in a case where red, green, and blue projection light rays output in a time-division manner), when the color of each projection light ray becomes closer to a color of a pointing light ray, detection accuracy in detecting a pointing image is degraded. As a result, detection accuracy in detecting a pointed position is degraded. Hence, for example, a temporal pattern of the color of the pointing light ray may be controlled such that the temporal pattern does not overlap a temporal pattern of the color of each projection light ray.

Note that in a case where the output parameters are controlled on the basis of the environment of the point target space, for example, in a case where the illumination environment of the point target space is fixed, and the color of illumination and the like hardly change, at least one of the intensity of the pointing light ray, the sectional size of the pointing light ray, or the sectional shape of the pointing light ray is preferentially changed. Furthermore, the sensor parameters are changed accordance with the change of the output parameters.

On the other hand, in a case where the illumination environment of the point target space largely changes or in a case where the illumination environment is unknown, for example, the color of the pointing light ray is preferentially changed.

Note that in a case where the color of the illumination light ray and the color of the pointed surface are fixed and hardly change, for example, the color of the pointing light ray may fixed and unchanged.

Furthermore, for example, it is assumed that in a case where the pointing light ray is reflected by the irradiated surface, the color of the reflected light ray is changed due to an influence of the irradiated surface, so that the color of the pointing image is largely different from the color of the pointing light ray. In this case, the range of the color of the pointing image included in the detection parameters becomes inappropriate, and the detection accuracy in detecting the pointing image is degraded. As a result, there is a possibility that the detection accuracy in detecting the pointed position is degraded. In order to address this issue, for example, adjusting the color of the pointing light ray or the range of the color of the pointing image in the detection parameters improves the detection accuracy in detecting the pointing image.

Note that, for example, the control parameters may be controlled on the basis of both the result of detection on the pointing image in the captured image and the environment of the point target space.

Furthermore, for example the control parameters (particularly the detection parameters) may be controlled on the basis of the output information received from the pointing apparatus 13.

<Modification Regarding Control Parameters>

The kinds of the foregoing control parameters (the output parameters, the detection parameters, and the sensor parameters) are merely exemplary, and the kinds of the parameters can be added or reduced.

Furthermore, at least one of the detection parameters or the sensor parameters may take fixed values so that an automatic adjustment is not made. For example, only the output parameters may be automatically adjusted only the output parameters and detection parameters may be automatically adjusted, or only the output parameters and sensor parameters may be automatically adjusted. Even if at least one of the detection parameters or the sensor parameters take fixed values, the method of outputting the pointing light ray is appropriately set in such a manner that the output parameters are automatically adjusted. The detection accuracy in detecting the pointed position is therefore improved.

<Other Modifications>

The foregoing description concerns the example in which a pointed position is detected on the basis of a captured image captured by the image sensor 31. The present technology is also applicable to a case where a pointed position is detected on the basis of sensor data acquired by another sensor.

Furthermore, the division of functions among the sensor unit 11, information processing apparatus 12, and processing unit 14 illustrate in FIG. 2 is merely exemplary, and is changeable. For example, the information processing apparatus 12 can be provided with at least one of the sensor unit 11 or the processing unit 14. Furthermore, for example, at least one of the sensor unit 11 or the processing unit 14 can perform a part of the functions of the information processing apparatus 12.

Moreover, for example, the method of outputting the pointing light ray can be deleted from the output information.

Furthermore, the foregoing description concerns the example in which an image projection position of the projector 71 is controlled on the basis of a result of detection on a pointed position. The result of detection on the pointed position is usable for another purpose. In this case, the processing unit 14 is provided with at least one of hardware or software that uses the result of detection on the pointed position.

Moreover, the present technology is also applicable to a system that uses both the irradiation-type pointing apparatus 13 and the output-type pointing apparatus 201. Also in this case, for example, output control information is individually transmitted to each pointing apparatus, and output parameters are set for each pointing apparatus, so that a pointing light ray from each pointing apparatus is individually controlled.

### 5. Others

<Configuration Example of Computer>

The foregoing series of processing tasks can be executed by hardware and can also be executed by software. In a case where the series of processing tasks is executed by software, a program constituting the software is installed in a computer. Here, examples of the computer include a computer incorporated in dedicated hardware, a general-purpose personal computer, for example, capable of executing various functions by installing various programs, and the like.

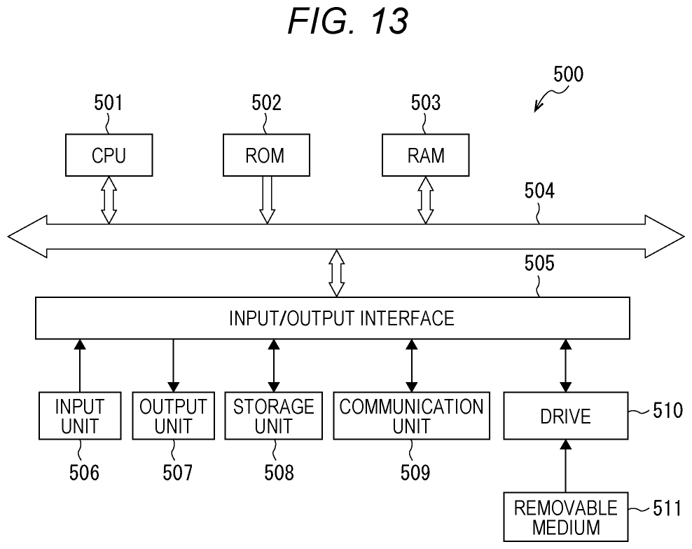

FIG. 13 is a block diagram that illustrates a configuration example of hardware in a computer that installs therein the program to execute the foregoing series of processing tasks.

In a computer 500, a central processing unit (CPU) 501, a read only memory (ROM) 502, and a random access memory (RAM) 503 are mutually connected via a bus 504.

Moreover, an input/output interface 505 is connected to the bus 504. An input unit 506, an output unit 507, a storage unit 508, a communication unit 509, and a drive 510 are connected to the input/output interface 505.

The input unit 506 includes an input switch, a button, a microphone, an image capturing element, and the like. The output unit 507 includes a display, a speaker, and the like. The storage unit 508 includes a hard disk, a nonvolatile memory, and the like. The communication unit 509 includes a network interface and the like. The drive 510 drives a removable medium 511 such as a magnetic disk, an optical disk, a magneto-optical disk, or a semiconductor memory.

In the computer 500 configured as described above, the CPU 501 loads, for example, a program recorded in the storage unit 508, onto the RAM 503 via the input/output interface 505 and the bus 504 to execute the program, thereby carrying out the foregoing series of processing tasks.

The program to be executed by the computer 500 (the CPU 501) can be provided while being recorded in, for example, the removable medium 511 as a package medium or the like. Furthermore, the program can be provided via a wired or wireless transmission medium such as a local area network, the Internet, or digital satellite broadcasting.

In the computer 500, the program can be installed in the storage unit 508 via the input/output interface 505 in such a manner that the removable medium 511 is mounted to the drive 510. Furthermore, the program can be received at the communication unit 509 via a wired or wireless transmission medium, and can be installed in the storage unit 508. In addition, the program can be previously installed in the ROM 502 or the storage unit 508.

Note that the program to be executed by the computer may be a program by which processing tasks are carried out in a time-series manner in accordance with the sequence described in the present specification, or may be a program by which processing tasks are carried out in parallel or are carried out at a required timing such as a time when the program is called up.

Furthermore, the term “system” in the present specification refers to an aggregate of a plurality of constituent elements (apparatuses, modules (components), and the like), and it does not matter whether or not all the constituent elements are in the same housing. Therefore, the term “system” involves both of a plurality of apparatuses accommodated in separate housings and connected to one another via a network and a single apparatus in which a plurality of modules is accommodated in a single housing.

Moreover, embodiments of the present technology are not limited to the foregoing embodiments, and various variations can be made without departing from the gist of the present technology.

For example, the present technology can take a configuration of cloud computing in which a plurality of apparatuses processes one function via a network in collaboration with one another on a task-sharing basis.

Furthermore, the respective steps described with reference to the foregoing flowcharts can be executed by a single apparatus or can be executed by a plurality of apparatuses with the steps divided among the plurality of apparatuses.

Moreover, in a case where a single step includes a plurality of processing tasks, the plurality of processing tasks included in the single step can be executed by a single apparatus or can be executed by a plurality of apparatuses with the plurality of processing tasks divided among the plurality of apparatuses.

<Combination Example of Configurations>

The present technology can adopt the following configurations.
(1)

An information processing apparatus including:

a pointed position detection unit configured to detect a pointed position pointed in a space with a pointing light ray from a pointing apparatus, on the basis of output information indicating an output state of the pointing light ray and sensor data detected in the space; and

a pointing light ray control unit configured to control output of the pointing light ray from the pointing light ray of the pointing apparatus on the basis of a result of detection on the pointed position.
(2)

The information processing apparatus as recited in (1), in which

the pointing light ray control unit controls a method of outputting the pointing light ray.
(3)

The information processing apparatus as recited in (2), in which

the pointing light ray control unit controls an output parameter indicating the method of controlling the pointing light ray.
(4)

The information processing apparatus as recited in (3), in which

the output parameter includes at least one of an intensity, a sectional size, a sectional shape, a color, or a temporal pattern of the pointing light ray.
(5)

The information processing apparatus as recited in any of (2) to (4), further including:

a detection control unit configured to control a detection parameter for use in detecting the pointed position, on the basis of the method of outputting the pointing light ray.
(6)

The information processing apparatus as recited in (5), in which

the detection parameter includes at least one of brightness, a size, a shape, a color, or a temporal pattern of a pointing image as an image formed by the pointing light ray.
(7)

The information processing apparatus as recited in any of (2) to (6), in which

the pointing light ray control unit controls a plurality of the pointing apparatuses such that the pointing apparatuses output the pointing light rays by different output methods, respectively.
(8)

The information processing apparatus as recited any of (1) to (7), further including:

a sensor control unit configured to control a sensor parameter for use in controlling a sensor configured to detect the sensor data, on the basis of the result of detection on the pointed position.
(9)

The information processing apparatus as recited in (8), in which

the sensor includes an image sensor, and

the sensor parameter includes at least one of a gain, a shutter speed, or an aperture of the image sensor.
(10)

The information processing apparatus as recited in any of (1) to (9), in which

the sensor data includes data on a captured image of an interior of the space, and

the pointing light ray control unit controls output of the pointing light ray, on the basis of a result of detection on a pointing image including an image formed by the pointing light ray, in the image.
(11)

The information processing apparatus as recited in (10), in which

the pointing light ray control unit preferentially changes at least one of an intensity, a sectional size, or a sectional shape of the pointing light ray in a case where a candidate for the pointing image is not detected in the image.
(12)

The information processing apparatus as recited in (10) or (11), in which

the pointing light ray control unit preferentially changes at least one of a color or a temporal pattern of the pointing light ray in a case where a plurality of candidates for the pointing image is detected in the image.
(13)

The information processing apparatus as recited in any of (1) to (12), in which

the pointing light ray control unit controls output of the pointing light ray on the basis of an environment of the space.
(14)

The information processing apparatus as recited in (13), in which

the pointing light ray control unit controls at least one of an intensity or a sectional size of the pointing light ray on the basis of a distance between an irradiated surface irradiated with the pointing light ray and the pointing apparatus.
(15)

The information processing apparatus as recited in (13) or (14), in which

the pointing light ray control unit controls an intensity of the pointing light ray on the basis of a reflectance of an irradiated surface irradiated with the pointing light ray.
(16)

The information processing apparatus as recited in any of (13) to (15), in which

the pointing light ray control unit controls a color of the pointing light ray on the basis of at least one of a color of illumination in the space or a color of a surface to which the pointed position is pointed.
(17)

The information processing apparatus as recited in any of (13) to (16), in which

the pointing light ray control unit controls a temporal pattern of a color of the pointing light ray on the basis of a temporal pattern of a color of an image projected onto a surface to which the pointed position is pointed.
(18)

The information processing apparatus as recited in any of (1) to (17), in which

the output information contains presence or absence of output of the pointing light ray.
(19)

The information processing apparatus as recited in (18), is which

the output information further contains a method of outputting the pointing light ray.
(20)

The information processing apparatus as recited in any of (1) to (19), in which

the pointed position includes a position irradiated with the pointing light ray.
(21)

The information processing apparatus as recited in any of (1) to (19), in which

the pointed position includes a position from which the pointing light ray is output.
(22)

The information processing apparatus as recited in any of (1) to (21), is which

the pointed position is used in controlling a projection position of a projector capable of changing an image projection position.
(23)

The information processing apparatus as recited in any of (1) to (22), in which

the pointing light ray control unit generates output control information for use in controlling output of the pointing light ray,

the information processing apparatus further including:

a transmission unit configured to transmit the output control information to the pointing apparatus; and

a reception unit configured to receive the output information from the pointing apparatus.
(24)

An information processing method including:

detecting a pointed position pointed in a space with a pointing light ray from a pointing apparatus, on the basis of output formation indicating an output state of the pointing light ray and sensor data detected in the space; and

controlling output of the pointing light ray on the basis of a result of detection on the pointed position.
(25)

A computer-readable recording medium recording a program causing a computer to execute processing of:

detecting a pointed position pointed in a space with a pointing light ray from a pointing apparatus, on the basis of output information indicating an output state of the pointing light ray and sensor data detected in the space; and

controlling output of the pointing light ray on the basis of a result of detection on the pointed position.
(26)

A pointing apparatus including:

a pointing light ray output unit configured to output a pointing light ray pointing a pointed position;

a reception unit configured to receive, from an information processing apparatus, output control information for use in controlling output of the pointing light ray;

an output control unit configured to control output of the pointing light ray on the basis of the output control information, and configured to generate output information indicating an output state of the pointing light ray; and

a transmission unit configured to transmit the output information to the information processing apparatus.
(27)

The pointing apparatus as recited in (26), in which

the output information contains presence or absence of output of the pointing light ray.
(28)

The pointing apparatus as recited in (27), in which

the output information further contains a method of outputting the pointing light ray.
(29)

The pointing apparatus as recited in any of (26) to (28), in which

the output control information contains an output parameter indicating a method of outputting the pointing light ray.
(30)

The pointing apparatus as recited in (29), in which

the output parameter includes at least one of an intensity, a sectional size, a sectional shape, a color, or a temporal pattern of the pointing light ray.
(31)

An information processing system including:

a pointing apparatus; and

an information processing apparatus,

in which

the pointing apparatus includes:
a pointing light ray output unit configured to output a pointing light ray pointing a pointed position;
a first reception unit configured to receive, from the information processing apparatus, output control information for use in controlling output of the pointing light ray;
an output control unit configured to control output of the pointing light ray on the basis of the output control information, and configured to generate output information indicating an output state of the pointing light ray; and
a first transmission unit configured to transmit the output information to the information processing apparatus, and

the information processing apparatus includes:
a second reception unit configured to receive the output information from the pointing apparatus;
a pointed position detection unit configured to detect the pointed position on the basis of the output information and sensor data detected in a space where the pointed position pointed;
a pointing light ray control unit configured to generate the output control information on the basis of a result of detection on the pointed position; and
a second transmission unit configured to transmit the output control information to the pointing apparatus.

Note that the effects described in the present specification are merely exemplary and not limitative, and there may be achieved other effects.

### REFERENCE SIGNS LIST

1 Information processing system
11 Sensor unit
12 Information processing apparatus
13, 13a, 13b Pointing apparatus
14 Processing unit
31, 31a, 31b Image sensor
42 Control unit
43 Pointed position detection unit
45 Communication unit
51 Pointing light ray control unit
52 Sensor control unit
53 Detection control unit
61 Transmission unit
62 Reception unit
102 Control unit
103 Pointing light ray output unit
104 Communication unit
111 Output control unit
121 Reception unit
122 Transmission unit
201a to 201d Pointing apparatus

1. An information processing apparatus comprising:
a pointed position detection unit configured to detect a pointed position pointed in a space with a pointing light ray from a pointing apparatus, on a basis of output information indicating an output state of the pointing light ray and sensor data detected in the space; and
a pointing light ray control unit configured to control output of the pointing light ray from the pointing apparatus on a basis of a result of detection on the pointed position.

2. The information processing apparatus according to claim 1, wherein
the pointing light ray control unit controls method of outputting the pointing light ray.

3. The information processing apparatus according to claim 2, further comprising:
a detection control unit configured to control a detection parameter for use in detecting the pointed position, on a basis of the method of outputting the pointing light ray,
wherein
the information processing apparatus performs at least one of control of an output parameter indicating the method of outputting the pointing light ray, by the pointing light ray control unit or control of the detection parameter by the detection control unit.

4. The information processing apparatus according to claim 3, wherein
the output parameter includes at least one of an intensity, a sectional size, a sectional shape, a color, or a temporal pattern of the pointing light ray, and
the detection parameter includes at least one of a brightness, a size, a shape, a color, or a temporal pattern of a pointing image as an image formed by the pointing light ray.

5. The information processing apparatus according to claim 2, wherein
the pointing light ray control unit controls a plurality of the pointing apparatuses such that the pointing apparatuses output the pointing light rays by different output methods, respectively.

6. The information processing apparatus according to claim 1, further comprising:
a sensor control unit configured to control a sensor parameter for use in controlling a sensor configured to detect the sensor data, on a basis of the result of detection on the pointed position.

7. The information processing apparatus according to claim 1, wherein
the sensor data comprises data on a captured image of an interior of the space, and
the pointing light ray control unit controls output of the pointing light ray, on a basis of a result of detection on a pointing image comprising an image formed by the pointing light ray, in the image.

8. The information processing apparatus according to claim 7, wherein
the pointing light ray control unit preferentially changes at least one of an intensity, a sectional size, or a sectional shape of the pointing light ray in a case where a candidate for the pointing image is not detected in the image.

9. The information processing apparatus according to claim 7, wherein
the pointing light ray control unit preferentially changes at least one of a color or a temporal pattern of the pointing light ray in a case where a plurality of candidates for the pointing image is detected in the image.

10. The information processing apparatus according to claim 1, wherein
the pointing light ray control unit controls output of the pointing light ray on a basis of an environment of the space.

11. The information processing apparatus according to claim 10, wherein
the pointing light ray control unit controls at least one of an intensity or a sectional size of the pointing light ray on a basis of a distance between an irradiated surface irradiated with the pointing light ray and the pointing apparatus.

12. The information processing apparatus according to claim 10, wherein
the pointing light ray control unit controls an intensity of the pointing light ray on a basis of a reflectance of an irradiated surface irradiated with the pointing light ray.

13. The information processing apparatus according to claim 10, wherein
the pointing light ray control unit controls a color of the pointing light ray on a basis of at least one of a color of illumination in the space or a color of a surface to which the pointed position is pointed.

14. The information processing apparatus according to claim 10, wherein
the pointing light ray control unit controls temporal pattern of a color of the pointing light ray on a basis of a temporal pattern of a color of an image projected onto a surface to which the pointed position is pointed.

15. The information processing apparatus according to claim 1, wherein
the output information contains presence or absence of output of the pointing light ray.

16. The information processing apparatus according to claim 15, wherein
the output information further contains a method of outputting the pointing light ray.

17. The information processing apparatus according to claim 1, wherein
the pointed position is used in controlling a projection position of a projector capable of changing an image projection position.

18. The information processing apparatus according to claim 1, wherein
the pointing light ray control unit generates output control information for use in controlling output of the pointing light ray,
the information processing apparatus, further comprising:
a transmission unit configured to transmit the output control information to the pointing apparatus; and
a reception unit configured to receive the output information from the pointing apparatus.

19. An information processing method comprising:
detecting a pointed position pointed in a space with a pointing light ray from a pointing apparatus, on a basis of output information indicating an output state of the pointing light ray and sensor data detected in the space; and
controlling output of the pointing ray on a basis of a result of detection on the pointed position.

20. A computer-readable recording medium recording a program causing a computer to execute processing of:
detecting a pointed position pointed in a space with a pointing light ray from a pointing apparatus, on a basis of output information indicating an output state of the pointing light ray and sensor data detected in the space; and
controlling output of the pointing light ray on a basis of a result of detection on the pointed position.
